(19) United States
(12) Patent Application Publication
(10) Pub. No.: US 2021/0297757 A1
(43) Pub. Date: Sep. 23, 2021

(54) SPATIAL SPECTRAL MESH

(71) Applicant: Panduit Corp., Tinley Park, IL (US)

(72) Inventors: Jose M. Castro, Naperville, IL (US); Richard J. Pimpinella, Frankfort, IL (US); Robert A. Reid, Battle Ground, IN (US); Bulent Kose, Burr Ridge, IL (US); Yu Huang, Orland Park, IL (US); Asher S. Novick, Chicago, IL (US)

(73) Assignee: Panduit Corp., Tinley Park, IL (US)

(21) Appl. No.: 17/260,310

(22) PCT Filed: Jul. 11, 2019
(86) PCT No.: PCT/US2019/041377

§ 371 Date: Jan. 14, 2021

Related U.S. Application Data
(60) Provisional application No. 62/696,907, filed on Jul. 12, 2018.

(51) Int. Cl. H04Q 11/00

(52) U.S. Cl. CPC H04Q 11/0005; H04Q 2011/0056; H04Q 2011/0026; H04Q 2011/0009

(57) ABSTRACT

A fiber optic interconnection assembly has a plurality of leaf components and a plurality of spine components. Each leaf component of the plurality of leaf components is connected to each spine component of the plurality of spine components. Each spine components of the plurality of spine components is connected to each leaf component of the plurality of leaf components. Wherein the connections for each leaf component to each of the spine components is at a different wavelength and the connections for each spine component to each of the leaf components is at a different wavelength.

### CROSS REFERENCE TO RELATED APPLICATION

This application claims priority to U.S. Provisional Application No. 62/696,907, filed Jul. 12, 2018, the subject matter of which is hereby incorporated by reference in its entirety.

### BACKGROUND OF THE INVENTION

The use of optical fiber for the transmission of communication signals has been rapidly growing in importance due to its high bandwidth, low attenuation, and other distinct advantages including, radiation immunity, small size, and lightweight. Data center architectures using optical fiber are evolving to meet the global traffic demands, and the increasing number of users and applications. The rise of cloud data centers, and in particular the hyperscale cloud has produced significant changes in the enterprise IT business structure, network systems, and topologies. Moreover, cloud data center requirements are impacting technology roadmaps and standardization.

The wide adoption of server virtualization and advancements in data processing and storage technologies, have produced the growth of East-West traffic within the data center. Traditional three tier switch architectures comprising Core, Aggregation, and Access (CAA) layers, cannot provide the low and equalized latency channels required for East-Wes traffic. Moreover, since the CAA architecture utilizes spanning tree protocol to disable redundant paths and build a loop-free topology, it underutilizes the network capacity.

A new data center design called the Clos Network-based. Spine-and-Leaf architecture was developed to overcome these limitations. A Clos network is a multilevel circuit switching network, introduced by Charles Clos around 1952. Initially, this network was devised to increase the capacity of crossbar switches. It became less relevant due to the development and adoption of very large scale integration (VLSI) techniques. The use of complex optical interconnect topologies initially for high performance computing (HPC) and later for cloud data centers, makes this architecture relevant again. The Clos network topology utilizes two types of switches, Spine and Leaf Each Spine is connected to each Leaf. The work can scale horizontally minimizing the latency and non-uniformity by simply adding more Spine and Leaf switches.

This architecture has been proven to deliver high-bandwidth and low-latency (only two hops to reach destination), with the ability to provide low oversubscription connectivity. However, for large numbers of switches the architecture requires a complex mesh with large numbers of fibers and connectors, which increasing the cost and complexity of the installation, decreasing the reliability of the network.

The deployment and scaling of data center networks using transpose boxes has been disclosed in previous art. The transpose box connects switches in different layers of the mesh network. However, scaling using optical fibers does not reduce the complexity of the interconnections or improve reliability.

Future data centers will require more flexible and adaptable networks than that which can be provided by traditional mesh approaches. Highly distributed computing, high levels of virtualization, and data replication, where VMware travel seamless along the physical infrastructure. A new mesh method and apparatus that utilize spatial and spectral paths to improve connectivity in data center, is disclosed here.

### SUMMARY OF THE INVENTION

Disclosed is a spatial-spectral optical mesh method and apparatus comprising an array of optical filters, optical connectors, and mirrors arranged such that positions in the vertical and horizontal dimensions are coincident, and where said optical elements satisfy specific spectral and angular and Bragg conditions. Said apparatus also comprises duplex or parallel sets of connectors and adaptors for input or output ports, and a set of collimating elements for directing light through one or more arrays of optical filters. Exemplary configurations that perform equivalent functionality are described.

### BRIEF DESCRIPTION OF THE DRAWINGS

FIG. 1 shows an exemplary mechanical subassembly 100, comprising a bidirectional link having 4 input and output ports, where each port comprises multiwavelength channels, and where the number of wavelengths is ≥4. Elements 102 and 108 represent mirrors, 106 and 110 are parallel fiber connectors (such as MPO) having mechanical alignment features, elements 104 and 112 are alignment devices and collimating lens arrays, and element 114 represents a two-dimensional array of filters.

FIG. 2 shows an exemplary embodiment of optical filters 201, 203, 205, and 207. Each filter is tuned to reflect (or transmit) a specified wavelength. The combined spectra of four light beams reflected by one row of the filter array is shown in 209.

FIG. 3 shows a 2-dimensional, 4-port array of said apparatus for inter-connecting 4 input ports 301, 303, 305, 307 to 4 output ports 309, 311, 313, 315, and where said optical filters are configured to redirect each of the 4 optical wavelength channels of said input ports to a preselected arrangement of wavelength channels to said output ports.

FIG. 4 shows a device composed of segmented reflectors (SR), i.e. thin film reflectors, or chirped holographic elements, that separate the wavelengths of 4 parallel ports.

FIG. 5 shows an array of 16 elements using 4 types of SR, 401, 403, 405, and 407, designed to reflect 4 wavelengths each at different input-output positions. A multi spectrum module (MSM) comprising 16 ports (16p) can fan-out/fan-in up to 16 parallel ports each carrying 4 wavelengths.

FIG. 6 shows a concatenated series of 4 MSM-16p, 501, 503, 505 and 507, Each MSM-16p is modified to have 4 different planes (or heights) inside each module (H1, H2, H3, H4). The resultant module, MSM-64p can fan-out/fan-in 64 parallel ports each having 4 wavelengths,

FIG. 7 shows the mesh produced by the MSM-4P.

FIG. 8 shows the mesh produced by the MSM-16,

FIG. 9 shows the mesh produced by the MSM-64.

FIG. 10 shows an example of a hybrid scaling methods for MSM-4p. In this embodiment, 801, 803, 805, 811, 813, and 815, are connected to ports 817, 819, 821, 823, and 827. However, a full mesh can only be produced by three ports. The remaining ports can be used to add external channels or to tap signals from different ports.

### DETAILED DESCRIPTION OF THE INVENTION

The present invention, describes an apparatus and design methods to enable efficient multi-port bi-directional connections using mesh topologies required in current and future data centers networks, and HPC applications. The apparatus according to the present invention uses optical technologies, i.e,. thin films or holographic optical elements implemented in 2D or 3D configurations, are disclosed here in configurations that enable large numbers of connections with less inter-connecting fibers. Systems and methods in accordance with the present invention leverages the wide adoption of multi-wavelength transceivers utilizing wavelength division multiplexing, i.e., SWDM, CDWM, DWDM, or WDM using 4, 8 or more wavelengths.

The disclosed apparatus can implement complex network topologies inside compact small form factor modules such as Panduit's HD Flex Cassettes, enabling the efficient scaling of data centers with less fiber and connections, and higher reliability.

The apparatus according to the present invention can assist in constructing leaf-spine data center fabrics using current 100 Gb/s CWDM4, SWDM4 or future transceivers operating at ≥200 Gbps. For example, transmission speeds of 200 Gbps (2 fiber-pairs 4 wavelengths, NRZ, 25 GBaud or 1 fiber-pair, 4 wavelengths, PAM-4, 25 GBaud), 400 Gbps (4 pairs, 4 wavelengths, NRZ 25 Gbaud), 800 Gbps, (4 pairs, 4 wavelengths, PAM-4,25 GBaud), 1.6 Tbps (4 pairs, 8 wavelengths, PAM-4, 25 GBaud, or 4 pairs, 4 wavelengths, PAM-4, 50 GBaud) or 3.2 Tbps (4 pairs, 8 wavelengths, PAM-4, 50 GBaud) among many other combination of number of fibers, allocated spectrum, modulation format and symbol rate.

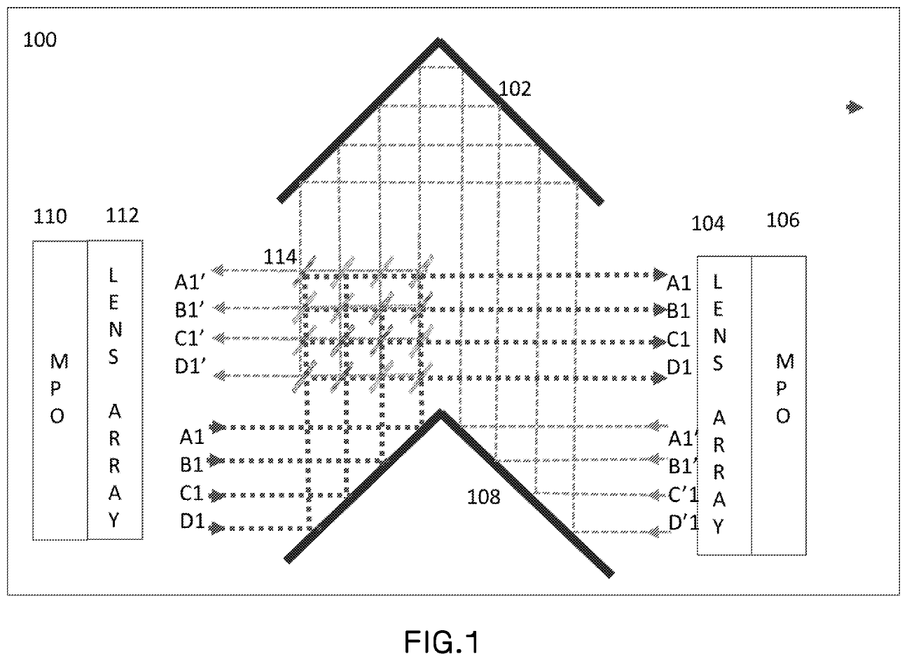

Examples of several embodiments of the present invention are illustrated in FIGS. 1-6. FIG. 1 shows the layout for an embodiment showing a 4-port network with bidirectional links. The apparatus uses mirrors 102 and 108 to direct the light to the input and output ports. It uses an array of spectral dependent reflectors, i.e., 114, to deflect two light beams from opposite directions to specific desired directions.

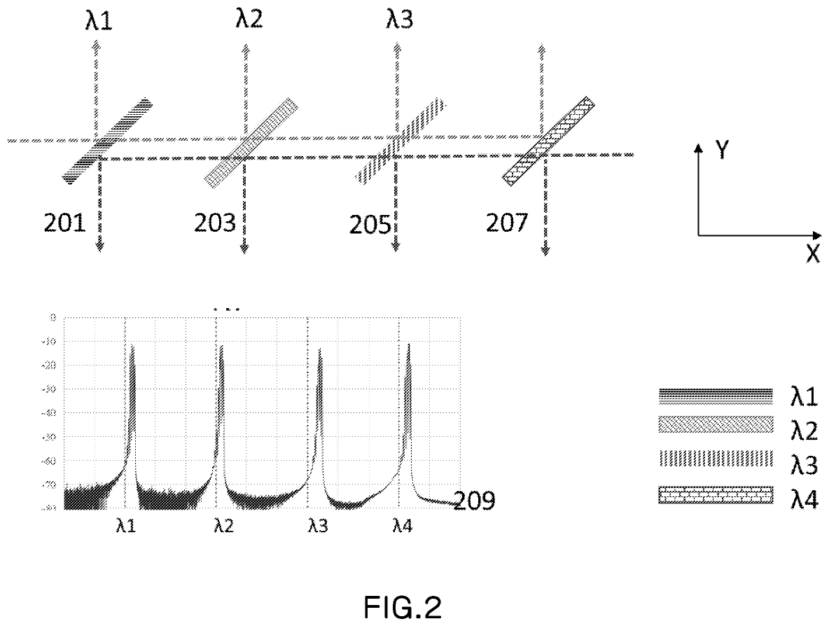

The input and output ports can utilize parallel connectivity such as MPO connectors, 106, 110. In the example shown in FIG. 1, 4-ports are using to transmit and 4-ports to receive from each side of the apparatus. Also, each port transmits signals using 4 wavelengths. In both sides of the device, lens arrays 104 and 112 are used to redirect the light to the array of optical reflectors 114. For the transmitted signals A1, B1, C1, D1, mirror 108 is used to direct the light to 114. The transmitter on the other side A1′. B1′,C1′,D1′, uses mirrors 108 and 102 to redirect the signals. The spectral dependent reflectors are tuned to reflect one specific wavelength and transmit the other wavelengths. For the signals transmitted from each ports the vertical reflectors separate the signals transmitted by wavelength (fan out), while the horizontal reflectors recombine different ports (fan in). It can be noted that each reflector is reused to enable the bi-directional link. An example describing the operation of one row of the reflector array 114, is shown in FIG. 2.

In this example, the first reflector, 201, reflects only λ1 and passes λ2, λ3, and λ4. The second reflector is tuned to reflect different wavelengths, λ2, λ3, and λ4 for 203, 205 and 207 respectively. Various optical filtering technologies can be utilized, i.e., thin film filters, or holographic elements. The reflective optical pass-band window matches the separation of the transmitted wavelength with a specified guard band to compensate for thermal drift, or nominal wavelength variation of the transceivers. In 209, the combined spectrum of the reflected signal is shown.

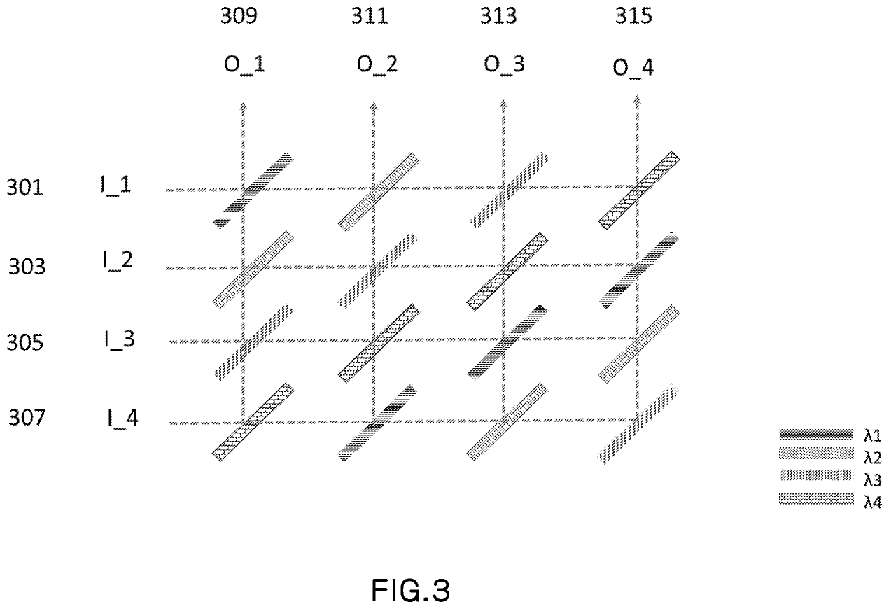

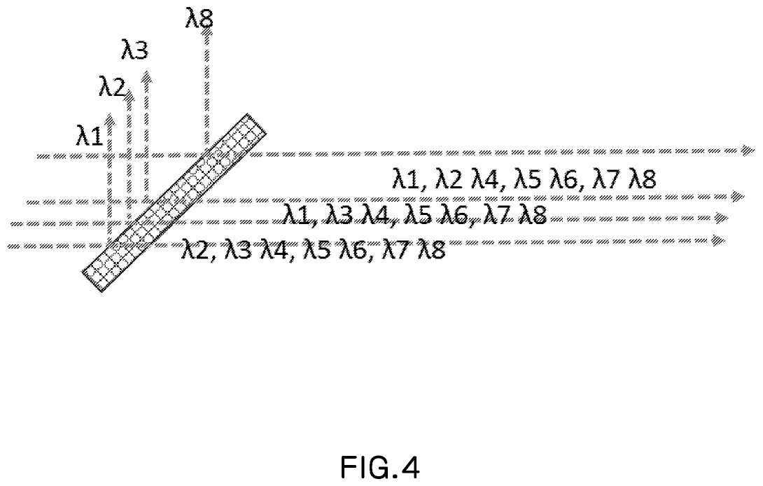

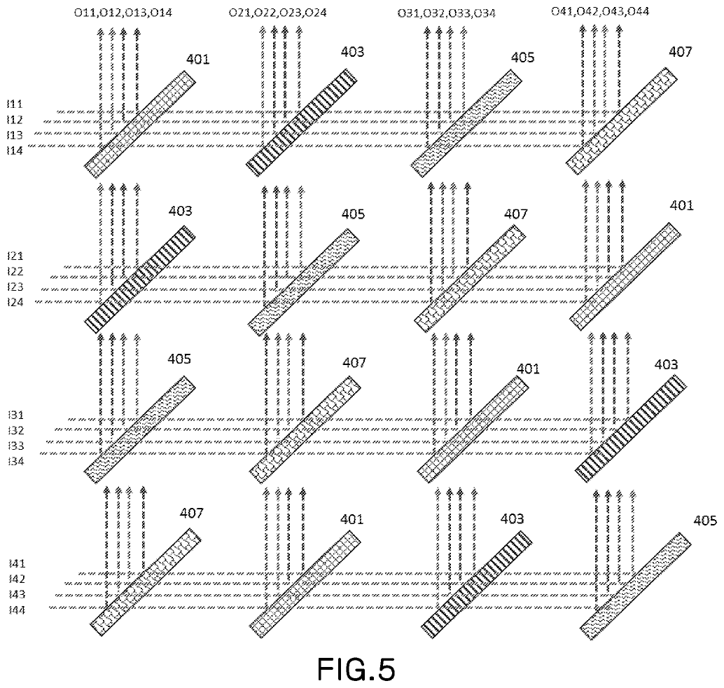

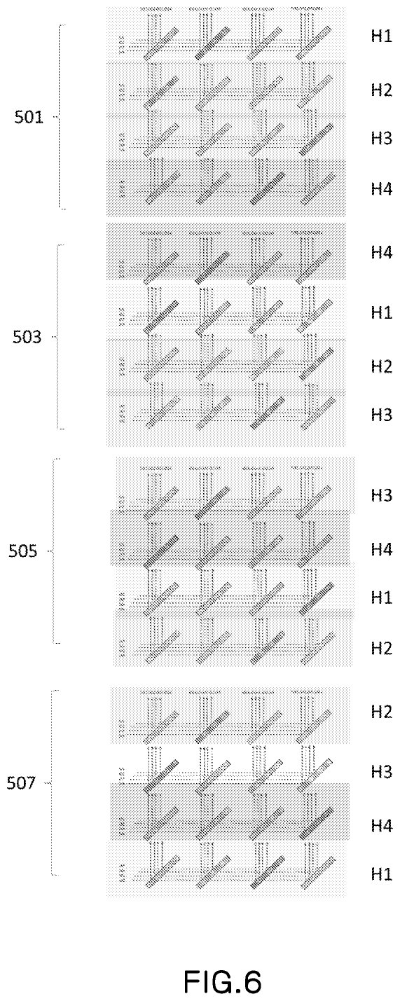

Details of array 114 are shown in FIG. 3, for a multi spectral module having four ports (MSM-4P). More compact MSM with larger numbers of ports can be implemented using segmented reflectors as shown in FIG. 4. This type of reflectors can enable MSM with 16 or more ports as shown in FIGS. 5-6.

The operation of the reflector array that corresponds to MSM-4P, shown in FIG. 4, is described as follows. The four input ports, 301, 303, 305, 307 are directed using the components described in FIG. 1 to an array of rows, comprising 4 reflectors, i.e., the ones shown in FIG. 2. The order or the detectors in each row is permuted to provide the required separation and recombination of wavelengths. For example, in FIG. 3, the horizontal position, or column number where each type of reflector is placed, depends on the row number. The geometrical arrangement can be mathematically represented by a modular addition or subtraction such as,

Pᵢⱼ=k mod(j+i−2,N_{λ})+1

where, is the position of the mirror in row i and column j, k is a proportionality factor, and N_{λ} is the number of wavelengths, 4 in this example.

The reflectors separate and recombine wavelengths of different input ports to the associated output ports 309, 311, 313 and 315. The relationships between input and output ports can be grouped per each transmitted wavelength as shown in table I.

TABLE I
connectivity map between input ports I_1, I_2, I_3, I4 and output
ports O_1, O_2, O_3, O_4.

| | λ1 | λ2 | λ3 | λ4 |
|---|---|---|---|---|
| O_1 | I_1 | I_2 | I_3 | I_4 |
| O_2 | I_4 | I_1 | I_2 | I_3 |
| O_3 | I_3 | I_4 | I_1 | I_2 |
| O_4 | I_2 | I_3 | I_4 | I_1 |

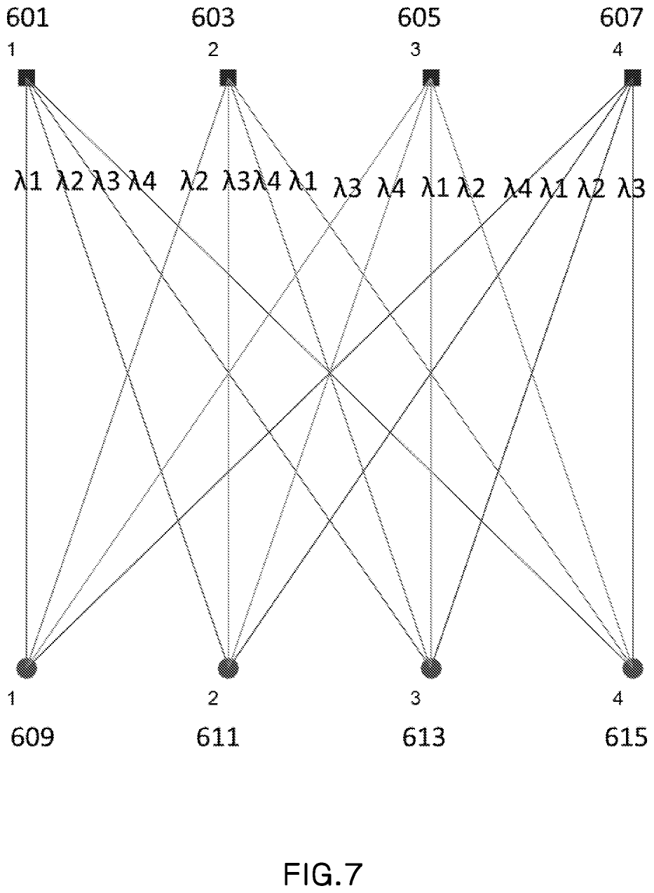

FIG. 7 shows the mesh produced with MSM using four ports. In this figure, the reflection paths of 114, produced an interconnection mesh that links each output port (601, 603, 605, 607) to all input ports (609, 611, 613, 615).

Also, it is noted that all the nodes launch or receive exactly, N_{λ}=4 wavelengths, which efficiently matches all the wavelength of the transceivers utilized. This four-port mesh is produced without fibers. The fibers are only used to connect the leaf switches to inputs of the MSM-4p and the spines switches to the output ports of the MSM-4P. It should be noted that the terms input and output ports are interchangeable here since links are bi-directional as shown in FIG. 1, and FIG. 2.

FIG. 4 shows an embodiment in which multi-wavelength reflectors, each reflecting N_{λ}4 wavelengths. Using this type of reflector arrays, more complex meshes can be constructed as shown in FIG. 5.

In this figure, an array of 16 elements using 4 types of multi-wavelength reflectors, 401, 403, 405 and 407, are designed to reflect 4 wavelengths and separate and recombine up to 16 parallel ports. The interconnection map per wavelength is shown in table II.

TABLE II
Interconnectivity map for 16 ports. The ports are grouped in arrays
of 4 elements per direction to estimate the number required MPO
connectors. For example, output port 1 is labeled O_1_1 and input
port 16 is I_16_4.

| | λ1 | λ2 | λ3 | λ4 |
|---|---|---|---|---|
| O_1_1 | I_1_4 | I_6_4 | I_11_4 | I_16_4 |
| O_1_2 | I_16_3 | I_1_3 | I_6_3 | I_11_3 |
| O_1_3 | I_11_2 | I_16_2 | I_1_2 | I_6_2 |
| O_1_4 | I_6_1 | I_11_1 | I_16_1 | I_1_1 |
| O_2_1 | I_16_4 | I_1_4 | I_6_4 | I_11_4 |
| O_2_2 | I_11_3 | I_16_3 | I_1_3 | I_6_3 |
| O_2_3 | I_6_2 | I_11_2 | I_16_2 | I_1_2 |
| O_2_4 | I_1_1 | I_6_1 | I_11_1 | I_16_1 |
| O_3_1 | I_11_4 | I_16_4 | I_1_4 | I_6_4 |
| O_3_2 | I_6_3 | I_11_3 | I_16_3 | I_1_3 |
| O_3_3 | I_1_2 | I_6_2 | I_11_2 | I_16_2 |
| O_3_4 | I_16_1 | I_1_1 | I_6_1 | I_11_1 |
| O_4_1 | I_6_4 | I_11_4 | I_16_4 | I_1_4 |
| O_4_2 | I_1_3 | I_6_3 | I_11_3 | I_16_3 |
| O_4_3 | I_16_2 | I_1_2 | I_6_2 | I_11_2 |
| O_4_4 | I_11_1 | I_16_1 | I_1_1 | I_6_1 |

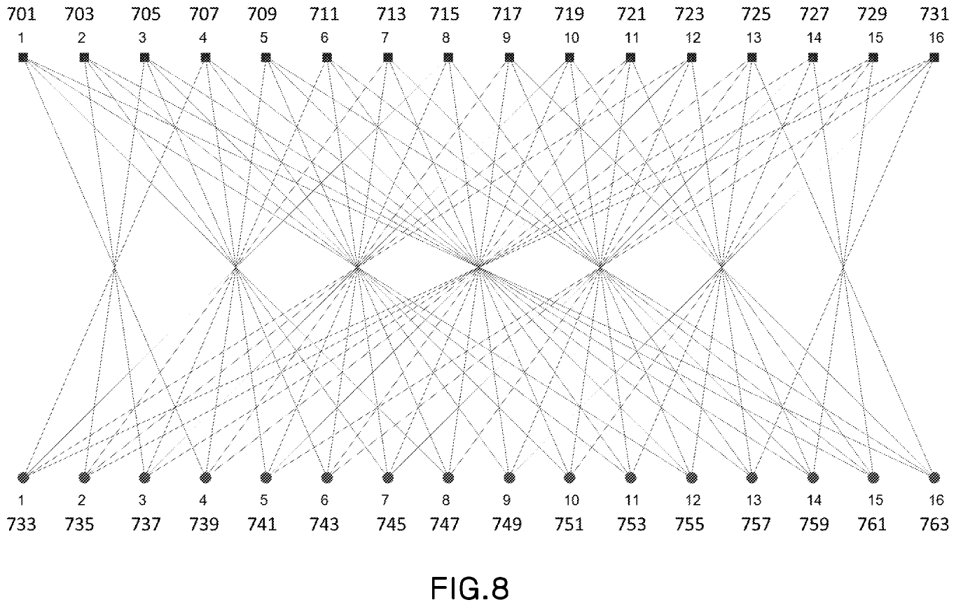

FIG. 8 shows the resultant mesh produced with MSM-16p connecting ports 701-731 to ports 733-763.

FIG. 6 shows an apparatus MSM for $4 ports or MSM-64p. The devices use 4 MSM-16p, 501, 503, 505, and 507 with, some small modifications: each reflector row of the MSM-16P is located at different heights. The specific heights, H1, H2, H3, H4, are designed in such a way to provide a separation and recombination. For example, the signals separated by the first row of 501, only recombine with light of the second row of 503, the third row of 505 and the last row of 507.

The heights are calculate following a modular addition or subtraction as described previously for the case of the reflector position. In this design, the input signals are feed horizontally (plane XY) whereas the output signals are collected in the vertical axis. It should be noted that due to the different heights, the reflected light does not hit more than 4 reflectors. The interconnection map per wavelength is shown in table III,

TABLE III
connectivity map between 64 input/output ports. The ports are grouped
in array groups of 4 to represent the number of MPO connectors.

| | λ1 | λ2 | λ3 | λ4 |
|---|---|---|---|---|
| O_1_1 | I_1_4 | I_6_4 | I_11_4 | I_16_4 |
| O_1_2 | I_16_3 | I_1_3 | I_6_3 | I_11_3 |
| O_1_3 | I_11_2 | I_16_2 | I_1_2 | I_6_2 |
| O_1_4 | I_6_1 | I_11_1 | I_16_1 | I_1_1 |
| O_2_1 | I_16_4 | I_1_4 | I_6_4 | I_11_4 |
| O_2_2 | I_11_3 | I_16_3 | I_1_3 | I_6_3 |
| O_2_3 | I_6_2 | I_11_2 | I_16_2 | I_1_2 |
| O_2_4 | I_1_1 | I_6_1 | I_11_1 | I_16_1 |
| O_3_1 | I_11_4 | I_16_4 | I_1_4 | I_6_4 |
| O_3_2 | I_6_3 | I_11_3 | I_16_3 | I_1_3 |
| O_3_3 | I_1_2 | I_6_2 | I_11_2 | I_16_2 |
| O_3_4 | I_16_1 | I_1_1 | I_6_1 | I_11_1 |
| O_4_1 | I_6_4 | I_11_4 | I_16_4 | I_1_4 |
| O_4_2 | I_1_3 | I_6_3 | I_11_3 | I_16_3 |
| O_4_3 | I_16_2 | I_1_2 | I_6_2 | I_11_2 |
| O_4_4 | I_11_1 | I_16_1 | I_1_1 | I_6_1 |
| O_5_1 | I_13_4 | I_2_4 | I_7_4 | I_12_4 |
| O_5_2 | I_12_3 | I_13_3 | I_2_3 | I_7_3 |
| O_5_3 | I_7_2 | I_12_2 | I_13_2 | I_2_2 |
| O_5_4 | I_2_1 | I_7_1 | I_12_1 | I_13_1 |
| O_6_1 | I_12_4 | I_13_4 | I_2_4 | I_7_4 |
| O_6_2 | I_7_3 | I_12_3 | I_13_3 | I_2_3 |
| O_6_3 | I_2_2 | I_7_2 | I_12_2 | I_13_2 |
| O_6_4 | I_13_1 | I_2_1 | I_7_1 | I_12_1 |
| O_7_1 | I_7_4 | I_12_4 | I_13_4 | I_2_4 |
| O_7_2 | I_2_3 | I_7_3 | I_12_3 | I_13_3 |
| O_7_3 | I_13_2 | I_2_2 | I_7_2 | I_12_2 |
| O_7_4 | I_12_1 | I_13_1 | I_2_1 | I_7_1 |
| O_8_1 | I_2_4 | I_7_4 | I_12_4 | I_13_4 |
| O_8_2 | I_13_3 | I_2_3 | I_7_3 | I_12_3 |
| O_8_3 | I_12_2 | I_13_2 | I_2_2 | I_7_2 |
| O_8_4 | I_7_1 | I_12_1 | I_13_1 | I_2_1 |
| O_9_1 | I_9_4 | I_14_4 | I_3_4 | I_8_4 |
| O_9_2 | I_8_3 | I_9_3 | I_14_3 | I_3_3 |
| O_9_3 | I_3_2 | I_8_2 | I_9_2 | I_14_2 |
| O_9_4 | I_14_1 | I_3_1 | I_8_1 | I_9_1 |
| O_10_1 | I_8_4 | I_9_4 | I_14_4 | I_3_4 |
| O_10_2 | I_3_3 | I_8_3 | I_9_3 | I_14_3 |
| O_10_3 | I_14_2 | I_3_2 | I_8_2 | I_9_2 |
| O_10_4 | I_9_1 | I_14_1 | I_3_1 | I_8_1 |
| O_11_1 | I_3_4 | I_8_4 | I_9_4 | I_14_4 |
| O_11_2 | I_14_3 | I_3_3 | I_8_3 | I_9_3 |
| O_11_3 | I_9_2 | I_14_2 | I_3_2 | I_8_2 |
| O_11_4 | I_8_1 | I_9_1 | I_14_1 | I_3_1 |
| O_12_1 | I_14_4 | I_3_4 | I_8_4 | I_9_4 |
| O_12_2 | I_9_3 | I_14_3 | I_3_3 | I_8_3 |
| O_12_3 | I_8_2 | I_9_2 | I_14_2 | I_3_2 |
| O_12_4 | I_3_1 | I_8_1 | I_9_1 | I_14_1 |
| O_13_1 | I_5_4 | I_10_4 | I_15_4 | I_4_4 |
| O_13_2 | I_4_3 | I_5_3 | I_10_3 | I_15_3 |
| O_13_3 | I_15_2 | I_4_2 | I_5_2 | I_10_2 |
| O_13_4 | I_10_1 | I_15_1 | I_4_1 | I_5_1 |
| O_14_1 | I_4_4 | I_5_4 | I_10_4 | I_15_4 |
| O_14_2 | I_15_3 | I_4_3 | I_5_3 | I_10_3 |
| O_14_3 | I_10_2 | I_15_2 | I_4_2 | I_5_2 |
| O_14_4 | I_5_1 | I_10_1 | I_15_1 | I_4_1 |
| O_15_1 | I_15_4 | I_4_4 | I_5_4 | I_10_4 |
| O_15_2 | I_10_3 | I_15_3 | I_4_3 | I_5_3 |
| O_15_3 | I_5_2 | I_10_2 | I_15_2 | I_4_2 |
| O_15_4 | I_4_1 | I_5_1 | I_10_1 | I_15_1 |
| O_16_1 | I_10_4 | I_15_4 | I_4_4 | I_5_4 |
| O_16_2 | I_5_3 | I_10_3 | I_15_3 | I_4_3 |
| O_16_3 | I_4_2 | I_5_2 | I_10_2 | I_15_2 |
| O_16_4 | I_15_1 | I_4_1 | I_5_1 | I_10_1 |

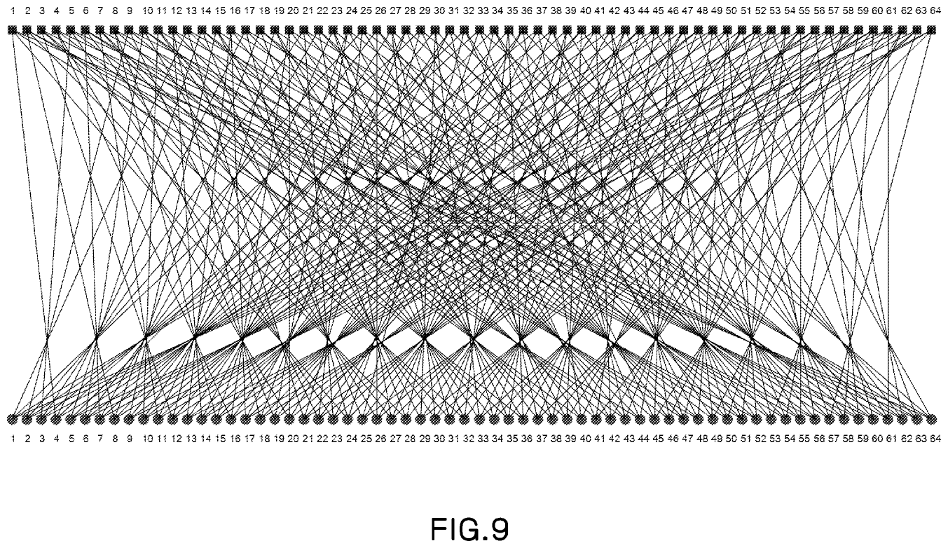

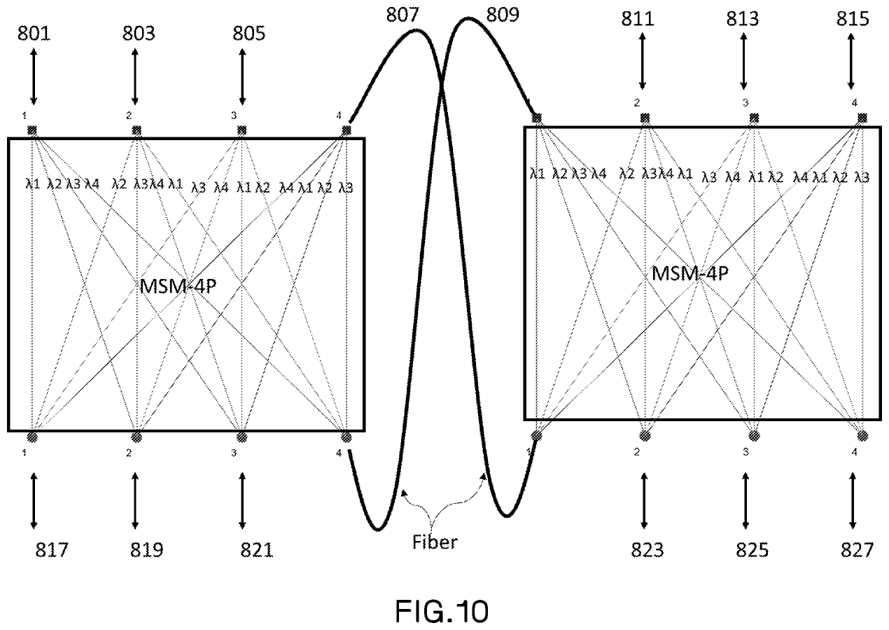

FIG. 9 shows the mesh produced with MSM-64p. Configuration designs using a mix of fiber and MSM modules can be used to scale up the size of the mesh. For example, FIG. 10 shows a hybrid scaling method for MSM 4p. In this example, 801, 803,805, 811, 813, and 815 are connected to ports 817, 819, 821, 823, and 827. However, a full mesh can only be produce with three ports. The other ports can be used to add external channels or to tap signals from different ports.

By adding tunability to the reflectors using thermal, electrical (LCD), or mechanical mean, a reconfigurable circuit based switch can be produced. Even if the MSM is passive, the servers can select the required ports to direct the signal, providing the means to switch the wavelength in which the data are being transmitted.

1. A fiber optic interconnection assembly comprising:
a plurality of leaf components; and
a plurality of spine components wherein each leaf component is of the plurality of leaf components is connected to each spine component of the plurality of spine components, each spine components of the plurality of spine components is connected to each leaf component of the plurality of leaf components, and further wherein the connections for each leaf component to each of the spine components is at a different wavelength and the connections for each spine component to each of the leaf components is at a different wavelength.

2. The fiber optic interconnection assembly of claim 1 wherein each spine component and each leaf component includes a reflector array.

3. A fiber optic interconnection assembly comprising
a plurality of N leaf components; and
a plurality of N spine components Wherein leaf component is connected to each spine component, each spine components is connected to each leaf component, and further wherein the connections for each spine component being at one of N different wavelengths with a wavelength for each connection being different and further wherein the connections for each leaf component being at one of N different wavelengths with a wavelength for each connection being different.

4. The fiber optic interconnection assembly of claim 1 wherein each spine and leaf component include a reflector array.
